(19) United States
(12) Patent Application Publication
(10) Pub. No.: US 2024/0356800 A1
(43) Pub. Date: Oct. 24, 2024

(54) CLOUD CONFIGURATION MANAGEMENT SYSTEM

(71) Applicant: Wells Fargo Bank, N.A., San Francisco, CA (US)

(72) Inventors: Eric Clifford Anderson, St Louis, MO (US); William Brian Bonner, Chandler, AZ (US); Lalita Narayan Dhal, Mountain House, CA (US); Aman, Bengaluru (IN)

(21) Appl. No.: 18/304,498

(22) Filed: Apr. 21, 2023

(51) Int. Cl. H04L 41/0806; H04L 41/0866

(52) U.S. Cl. CPC H04L 41/0806; H04L 41/0866

(57) ABSTRACT

An electronic online system is configured to: receive, at the electronic online system, a proposed cloud configuration, the proposed cloud configuration including a plurality of parameters for use in instantiating and deploying a cloud project on a cloud service provider, wherein at least one of the plurality of parameters has corresponding metadata to describe an owner of the at least one of the plurality of parameters; save the proposed cloud configuration in a pending approval queue; receive an indication of approval of the at least one of the plurality of parameters by the owner indicated in the metadata of the at least one of the plurality of parameters; and after approval of all of the plurality of parameters in the proposed cloud configuration, transmit the plurality of parameters to the cloud service provider to instantiate and deploy the cloud project.

### BACKGROUND

The Internet has enabled worldwide networking. Hundreds of services and applications are provided on the Internet. Although the Internet has been around for decades, it has only been in more recent years that the communication infrastructure has improved to a point where cloud computing is feasible. Cloud computing, simply put, is the delivery of various computing services over the Internet. The Internet is referred to as a cloud of computers, hence the origin of the term “cloud computing.”

To use cloud computing, a cloud service provider (CSP) provides resources, such as compute, storage, databases, accelerators, analytics, intelligence, networking, and other resources to consumers. The allotment of these resources is highly configurable by the consumer.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating control and data flow for developing and implementing a cloud configuration, according to an embodiment;

FIG. 3 is a flowchart illustrating a method for providing a cloud configuration management system, according to an embodiment; and

FIG. 4 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a cloud configuration management system. Cloud computing has become a way for businesses to augment or replace on-premises server farms. Maintaining applications and services in the cloud reduces costs for consumers because they no longer have to maintain on-site hardware, pay personnel to manage systems, or purchase software licenses that may go unused. However, there are several cloud service providers (CSP) and each CSP may offer different hardware, software, network, storage, and other resources. These resources may be referred to by nomenclature that is specific to a CSP. What is needed is a platform to better organize and standardize the offerings from various CSPs.

The systems and methods described herein provide for a cloud configuration management platform that supports change management, approval, and other flows for cloud configurations. Cloud configurations are used to configure deployment of software as a service (SaaS), platform as a service (PaaS), infrastructure as a service (IaaS), function as a service (FaaS), and other service models. When designing and configuring a deployment for a specific software application under a SaaS model, a consumer may have to set up one configuration for a first CSP and another different configuration for a second CSP. The configurations may be generally the same, but the specific names of the packages, hardware support level, and other aspects of the deployment may be different from CSP vendor to CSP vendor.

The cloud configuration management platform provides various functions to manage cloud service configurations. A policy layer is used to ensure that any planned configuration is approved by the appropriate internal parties before being deployed. Further, any changes to an existing cloud service configuration may be audited, reviewed, or approved before being deployed. A policy editor platform is used to interface with the policy layer and create, revise, and store policies that are used in an approval process.

The cloud configuration management platform may also provide a way to abstract cloud service offerings using generalized naming schemas. For instance, a first CSP may refer to a storage service as “archive storage” where a second CSP may refer to a similar long-term storage service as “offline storage.” In order to generalize and normalize the terminology between the CSPs, the cloud configuration management platform may use a metadata tag of “storage-365” to refer to a storage service that saves data for up to 365 days. This mechanism to tag the offerings from a CSP with metadata that more specifically describes the offerings removes “marketing speak” and other labels that may obfuscate the details of the service. Metadata tags may also be used to characterize CSP products with indications of reliability, security, value, cost, or the like.

The cloud configuration management platform may also be used to store cloud configurations, audit cloud configurations, translate cloud configurations from one CSP version to a second CSP version (for instance, to migrate a deployment from one CSP to another CSP), and alert system administrators of when a CSP's service is not performing according to the service level agreement defined in the configuration. These functions and others are described in more detail below.

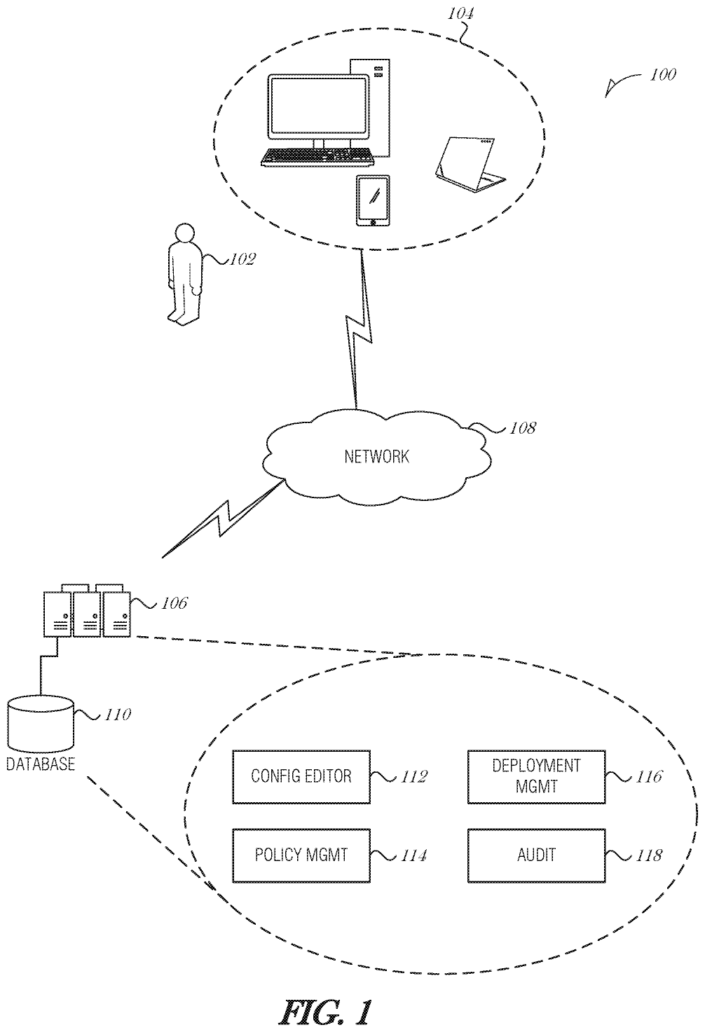

FIG. 1 is a diagram illustrating an operating environment 100, according to an embodiment. A user 102 may use a user device 104 to access a cloud configuration management system 106. The user device 104 may be of any type of form factor including, but not limited to a desktop computer, a mobile device, a laptop computer, a smartphone, a tablet device, a personal digital assistant, or the like. The user 102 may be a person who fulfils a role, such as a system administrator, a business executive, a group manager, or the like. Each role may have different permissions to execute functions or operations in the cloud configuration management system 106. For instance, an administrator may be allowed to create a new cloud configuration, delete an existing configuration, or revise a configuration. A person with a non-elevated privilege (e.g., a regular user) may only have permissions to deploy a configuration. People with managerial privileges may be able to review and approve proposed changes to cloud configurations.

The cloud configuration management system 106 may include various web servers, database servers, proxy devices, firewalls, storage devices, and network devices. The cloud configuration management system 106 may provide a web-based interface accessible via a uniform resource locator (URL). The cloud configuration management system 106 may provide various levels of security, such as requiring an account with a username and password, a secure channel (e.g., HTTPS), two-factor authentication, and the like.

To connect to the cloud configuration management system 106, the user 102 may execute an application (“app”) to connect via a network 108. In various examples, the servers and components in the operating environment 100 may communicate via one or more networks such as network 108. The network 108 may include one or more of local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 108 may include a single local area network (LAN) or wide-area network (WAN), or combinations of LANs or WANs, such as the Internet.

Data used in the cloud configuration management system 106 may be organized and stored in a variety of manners. For convenience, the organized collection of data is described herein as a database 110. The specific storage layout and model used in the database 110 may take a number of forms-indeed, the database 110 may utilize multiple models. The database 110 may be, but is not limited to, a relational database (e.g., SQL), non-relational database (NoSQL), a flat file database, object model, document details model, or a file system hierarchy. The database 110 may store data on one or more storage devices (e.g., a hard disk, random access memory (RAM), etc.). The storage devices may be in standalone arrays, part of one or more servers, and may be located in one or more geographic areas.

A database management system (DBMS) may be used to access the data stored within the database 110. The DBMS may offer options to search the database 110 using a query and then return data in the database 110 that meets the criteria in the query. For example, a SQL query may be utilized to retrieve all social media related to a specific type of investment strategy. Another query may retrieve online users that subscribe to the type of investment strategy. The DBMS may operate on one or more of the components of the cloud configuration management system 106.

The cloud configuration management system 106 provides management platform for cloud configurations. One function provided by the cloud configuration management system 106 is to create, edit, or delete cloud configurations. A cloud configuration includes the parameters used to instantiate and deploy a Software-as-a-Service (SaaS) project. Although the examples included in this document refer to SaaS projects and deployments of SaaS projects, it is understood that the cloud configuration management system 106 may be used to manage configurations for SaaS, PaaS, IaaS, FaaS, and the like.

In operation, a user 102 may log into the cloud configuration management system 106 to create or access cloud configurations. Depending on the privileges and the role of the user 102, various components of the cloud configuration management system 106 are visible and accessible. Example components include a configuration editor 112, a policy management system 114, a deployment management system 116, and an audit system 118. A user 102 may have access to one or more of these components 112-118.

The configuration editor 112 is used to create, revise, and delete cloud configurations. A cloud configuration includes parameters for a cloud project. Cloud projects may be created and managed by various groups, committees, or units in a business. Each project includes one or more resources, which include but are not limited to compute resources, storage resources, database resources, application resources, analytics resources, network resources, or the like. Security requirements may be associated with a project.

A cloud configuration includes configuration parameters for one or more projects, each of the projects having one or more cloud resources. Configuration parameters may include approved ranges of operation of a resource or ranges of operation for use of a resource. For instance, for a function resource, a number of application programming calls per minute may be enumerated; for a network resource, an acceptable range of megabytes (MB) per second may be defined; for a compute resource, a minimum and maximum number of virtual machines to spin up may be set; or for a storage resource, a total data consumption per day may be capped. Configuration parameters may also include security requirements, such as users, roles, groups, permissions, encryption keys, encryption standards, and the like. The cloud configuration may be stored in a structured format, such as JavaScript Object Notation (JSON), Extensible Markup Language (XML), or the like.

A cloud project is identified using a descriptive name, a unique identifier, or by other means. The unique identifier may be a system-generated identifier to uniquely identify the project across all projects hosted at the CSP. Additionally, the cloud project may include cloud resources such as database files, database queries, compute resources, storage resources, function resources (e.g., serverless functions), applications (e.g., “apps”), pre-built solutions (e.g., from an app marketplace), and the like. Each of these resources may be configured. For instance, a database query resource may be configured with the structured query language (SQL) command to execute, a recurring scheduled time to execute it, and permissions of which applications are allowed to execute the query. This is merely an example and it is understood that resource configuration may be handled in any number of ways.

The policy management system 114 is a control layer used that acts between the configuration editor 112 and the deployment management system 116. Users 102 that have appropriate permissions may review, approve, revise, deny, or otherwise manage cloud configurations that are made by the configuration editor 112. For instance, a manager may be provided privileges to review cloud configurations for an engineering group that she manages before the cloud configuration is deployed to a CSP. The manager may be notified, such as with an email, text message, or other communication, that a cloud configuration is available for review and approval. The manager may open pending cloud configurations to review whether resource allocation, cost, or other parameters are within bounds that may be set by the manager or other parts of the company.

For instance, a cloud configuration may be designed to have a data export daily. The data export may be expected to be around 3 TB (terabytes). However, due to company policy, this amount of data transfer exceeds some usage guidelines, and so the manager may adjust the recurring period from daily to weekly, adjust the query to produce a smaller result set, or the like.

After revising a cloud configuration, a notification may be provided to the submitting party that the cloud configuration is revised. This allows for negotiation of the cloud configuration between the submitter and the manager (approver) before being given a deployment schedule (e.g., pushed to live environment). The review-approval-resubmit cycle may be repeated multiple times before finally producing an approved cloud configuration.

The deployment management system 116 is used to interface with one or more cloud service providers (CSP) in order to implement an approved cloud configuration. The deployment management system 116 acts as a hub component and uses cloud configurations developed by the configuration editor 112, and approved by the policy management system 114, to direct a CSP platform to instantiate and execute one or more projects as described in the cloud configuration.

The deployment management system 116 may interface with a CSP using a command line interface (CLI), an application programming interface (API), an agent that resides on the cloud configuration management system 106 and interfaces with the CSP using a proprietary channel, or by other mechanisms. Additionally, or alternatively, a script, program, or other executable instructions may be generated by the deployment management system 116 based on the cloud configuration, for execution by the CSP to instantiate, deploy, revise, or otherwise manage a cloud project defined in the cloud configuration.

The deployment management system 116 may initiate deployment of a project via the cloud configuration, track progress of a project, notify users 102 of the state of the project, migrate a project from one CSP to another CSP, or perform other management operations at the deployment level.

The audit system 118 is used to monitor changes to cloud configurations, monitor cloud resources at a CSP, and determine whether any anomalies occur either during configuration changes or in use of cloud resources. For instance, the audit system 118 may determine that a cloud configuration is using a 90-day storage resource at the CSP for storing data for a short term. The 90-day storage resource may store the most-recent 90 days' worth of data. The CSP may refer to this as a “near-online storage.” For some reason, the CSP may change the “near-online” storage resource from using a 90-day period to 70-day period. This change may be detected by the audit system 118, which may notify users 102 that the change has occurred. Further, the cloud configuration using this storage resource may now be in violation of an acceptable retention period defined in the parameters of the cloud configuration. As such, the cloud configuration may have to undergo review and revision.

Additionally, the audit system 118 may extract a current configuration from an existing project that is on a CSP platform. Using an API, CLI, or other mechanism (e.g., screen scraping), the audit system 118 may obtain the working parameters of a project executing on a CSP. This may be stored as a “working configuration” and may be reviewed by a person or by the audit system 118 to determine if the working configuration is close to the approved cloud configuration that was initially deployed. The use of an extraction tool to obtain a working configuration from one CSP may be used to build a cloud configuration to be implemented at a second CSP. Using metadata tags, the configuration editor 112 or deployment management system 116 may translate cloud resources and parameters from one CSP's terminology to another CSP's terminology.

Metadata is data that describes data. Metadata, which may be stored as tags, may be stored in a metadata database. Metadata may be used to tag cloud resources, configuration parameters, and the like. Metadata may be used to describe owners or authorized users of configuration parameters, approved operating ranges of cloud resources or configuration parameters, policy data associated with cloud resource or configuration parameters, or the like. Metadata tags may be stored in the database 110

For instance, metadata tags may be used to tag one or more users 102 with a configuration parameter in a cloud configuration to indicate ownership of the configuration parameter. Owners are able to modify, or approve the modification of, a configuration parameter. Other user roles may also be defined and used to tag configuration parameters.

Metadata tags may also be used to indicate other facets of configuration parameters, such as whether a configuration parameter is of higher or lower business value, or whether a configuration parameter is more or less secure, or more or less reliable.

Metadata tags may be used, for example, to configure or alter a user interface (UI). For instance, in a UI of the configuration editor 112, a selection of cloud resources may be filtered by metadata tags to only display those available to the user 102, based on privileges expressed in the metadata tag. As another example, a UI of the configuration editor 112 may present available options for a parameter in a sorted list based on, for example, in order of increasing or decreasing business value, increasing or decreasing cost per unit time (e.g., $300 per hour), increasing or decreasing cost per usage (e.g., $5 per five VMs), or increasing or decreasing relative security of the tagged configuration parameter (e.g., encryption complexity of a storage option).

Metadata tags may also be referenced by the policy management system 114 or the deployment management system 116 to perform various operations, such as, for example, to identify who to contact for approval of a configuration parameter change.

Similar cloud resources may be named differently by different CSPs, so in some implementations, the configuration editor 112 uses metadata tags that have been normalized or generalized so that the user 102 does not need to understand CSP-specific terminology for their resources. For instance, one CSP may name a graphics processing unit (GPU) focused compute resource “cloud GPU” and another CSP may refer to GPU-focused compute resources as “GPU Optimized.” While a user may be able to discern the commonality between such resources, it may not always be the case when names are arbitrary and may be selected for their marketing jargon instead of using a descriptive label. As such, in an implementation, the GPU-focused compute resource may be referred to as a “GPU-compute” resource in the cloud configuration management system 106 and be mapped to the “cloud GPU” resource from one CSP and the “GPU Optimized” compute resource from the other CSP. Mappings of metadata tags may be stored in the database 110.

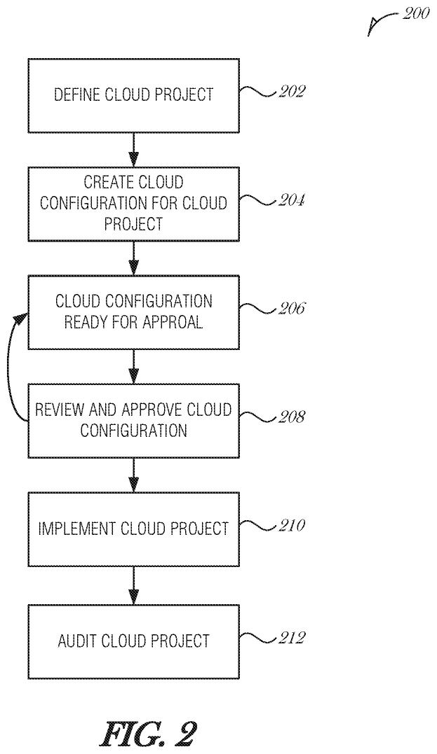

FIG. 2 is a flow diagram illustrating control and data flow 200 for developing and implementing a cloud configuration, according to an embodiment. At operation 202, a cloud project is defined. The project may be defined by a business group, for example, a Network Security group in an Information Technology Department. The cloud project may be for a specific technological function, such as a daily database update of a database stored in a cloud system. For instance, the daily database update may be a daily accounting of sales in a business, and the generation of reports of various summary data from the sales.

At operation 204, a person creates or modifies a cloud configuration. The person may be from the Network Security group, continuing with the example from above. The person may use an online electronic system, such as the configuration editor 112 of the cloud configuration management system 106.

At operation 206, after the person is finished creating the cloud configuration, the cloud configuration is set to a pending-approval state. Based on metadata, for example, the cloud configuration management system 106 may notify one or more people who are authorized to approve the cloud configuration. There may be several people's authorizations to approve the cloud configuration. For example, the cloud configuration may include cloud resources that are under control of different business groups and have different approving parties.

At operation 208, one or more people who are authorized to provide approval for the pending cloud configuration may review and approve or deny the cloud configuration. The people reviewing the cloud configuration may use an online electronic system, such as the policy management system 114 of the cloud configuration management system 106. If a cloud configuration is denied, at least in part, then a notification may be provided to the submitting party (e.g., the person who created the cloud configuration and submitted it for approval). The operational flow returns to operation 206. The approval review process may continue to cycle between operations 206 and 208 until the cloud configuration is either approved or finally denied. If the cloud configuration creation or modification is denied, then either the cloud project is terminated or left unchanged, respectively.

At operation 210, if the cloud configuration is approved, then the cloud configuration is implemented at a cloud service provider (CSP). For instance, the policy management system 114 notifies the configuration editor 112 that the cloud configuration is approved. In an example, the configuration editor 112 updates a database that stores the cloud configuration, to change a field to indicate an approval state of the cloud configuration. In another example, the policy management system 114 is able to update the database that stores the cloud configuration. Other mechanisms may be used as well.

At operation 212, once the cloud configuration is a live project, various aspects of the project may be monitored for audit purposes. For instance, the performance of the project to determine whether any anomalies occur either during configuration changes or in use of cloud resources.

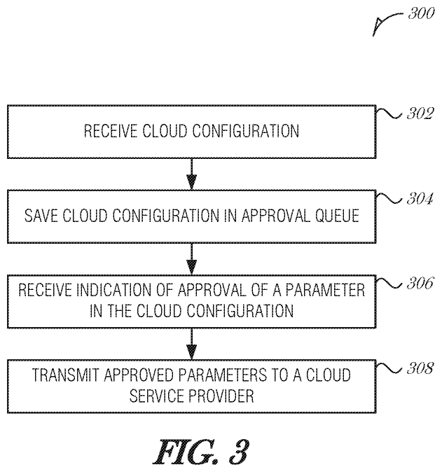

FIG. 3 is a flowchart illustrating a method 300 for providing a cloud configuration management system, according to an embodiment. The method 300 may be performed by an electronic system (e.g., cloud configuration management system 106) or any of the modules, logic, circuits, processors, or components described herein.

At 302, a proposed cloud configuration is received receiving at the electronic online system. The proposed cloud configuration includes a plurality of parameters for use in instantiating and deploying a cloud project on a cloud service provider. At least one of the plurality of parameters has corresponding metadata to describe an owner of the at least one of the plurality of parameters.

In an embodiment, the plurality of parameters are used to configure a plurality of cloud resources. In a further embodiment, the plurality of cloud resources include compute resources or storage resources. In another embodiment, the proposed cloud configuration includes security requirements of at least one of the plurality of cloud resources. In a further embodiment, the security requirements include an indication of an encryption strength for use with the at least one of the plurality of cloud resources.

In an embodiment, at least one of the plurality of parameters has corresponding metadata to describe a business value of the at least one of the plurality of parameters.

In an embodiment, at least one of the plurality of parameters has corresponding metadata to describe a business cost of the at least one of the plurality of parameters.

In an embodiment, at least one of the plurality of parameters has corresponding metadata to describe an approved range of operation of the at least one of the plurality of parameters.

In an embodiment, at least one of the plurality of parameters has corresponding metadata to describe a security level of the at least one of the plurality of parameters.

At 304, the proposed cloud configuration is saved in a pending approval queue. The queue may be implemented as a table in an electronic database, for instance.

At 306, an indication of approval of the at least one of the plurality of parameters by the owner indicated in the metadata of the at least one of the plurality of parameters, is received.

At 308, after approval of all of the plurality of parameters in the proposed cloud configuration, the plurality of parameters is transmitted to the cloud service provider to instantiate and deploy the cloud project.

In an embodiment, transmitting the plurality of parameters to the cloud service provider includes using an application programming interface (API) to transmit the plurality of parameters. In an embodiment, transmitting the plurality of parameters to the cloud service provider includes using a command line interface (CLI) to transmit the plurality of parameters. In an embodiment, transmitting the plurality of parameters to the cloud service provider includes executing a script to transmit the plurality of parameters.

In an embodiment, the method 300 includes auditing the cloud project.

In an embodiment, the method 300 includes extracting parameters of a deployed cloud configuration based on the cloud project, and comparing the parameters of the deployed cloud configuration with the plurality of parameters in the proposed cloud configuration to determine whether an anomaly exists.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

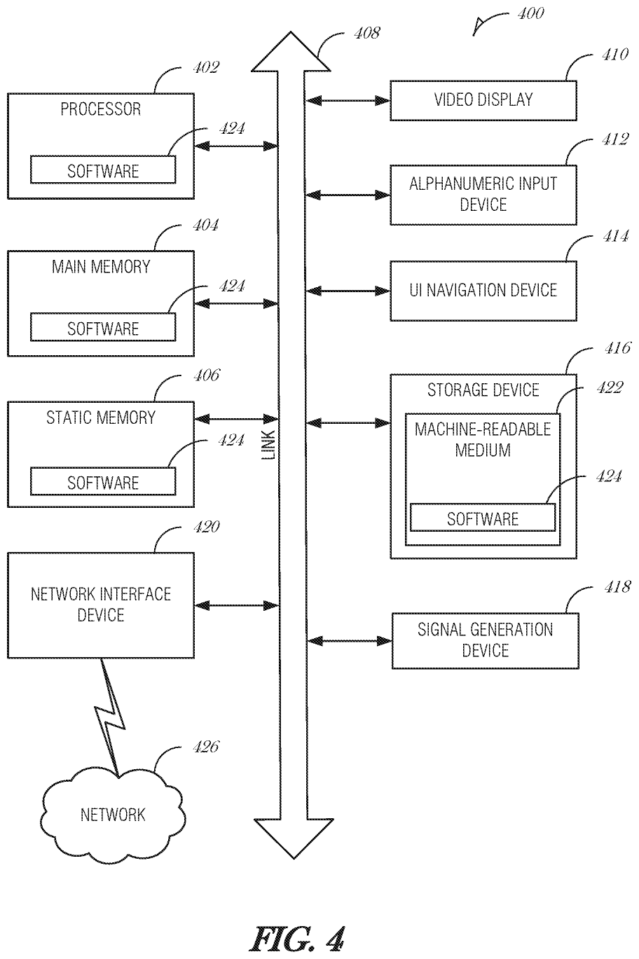

FIG. 4 is a block diagram illustrating a machine in the example form of a computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is an electronic online system comprising: a processor subsystem; and a memory including instructions, which when executed by the processor subsystem, cause the processor subsystem to: receive, at the electronic online system, a proposed cloud configuration, the proposed cloud configuration including a plurality of parameters for use in instantiating and deploying a cloud project on a cloud service provider, wherein at least one of the plurality of parameters has corresponding metadata to describe an owner of the at least one of the plurality of parameters; save the proposed cloud configuration in a pending approval queue; receive an indication of approval of the at least one of the plurality of parameters by the owner indicated in the metadata of the at least one of the plurality of parameters; and after approval of all of the plurality of parameters in the proposed cloud configuration, transmit the plurality of parameters to the cloud service provider to instantiate and deploy the cloud project.

In Example 2, the subject matter of Example 1 includes, wherein the plurality of parameters are used to configure a plurality of cloud resources.

In Example 3, the subject matter of Example 2 includes, wherein the plurality of cloud resources include compute resources or storage resources.

In Example 4, the subject matter of Examples 2-3 includes, wherein the proposed cloud configuration includes security requirements of at least one of the plurality of cloud resources.

In Example 5, the subject matter of Example 4 includes, wherein the security requirements include an indication of an encryption strength for use with the at least one of the plurality of cloud resources.

In Example 6, the subject matter of Examples 1-5 includes, wherein at least one of the plurality of parameters has corresponding metadata to describe a business value of the at least one of the plurality of parameters.

In Example 7, the subject matter of Examples 1-6 includes, wherein at least one of the plurality of parameters has corresponding metadata to describe a business cost of the at least one of the plurality of parameters.

In Example 8, the subject matter of Examples 1-7 includes, wherein at least one of the plurality of parameters has corresponding metadata to describe an approved range of operation of the at least one of the plurality of parameters.

In Example 9, the subject matter of Examples 1-8 includes, wherein at least one of the plurality of parameters has corresponding metadata to describe a security level of the at least one of the plurality of parameters.

In Example 10, the subject matter of Examples 1-9 includes, wherein to transmit the plurality of parameters to the cloud service provider, the processor subsystem is to use an application programming interface (API) to transmit the plurality of parameters.

In Example 11, the subject matter of Examples 1-10 includes, wherein to transmit the plurality of parameters to the cloud service provider, the processor subsystem is to use a command line interface (CLI) to transmit the plurality of parameters.

In Example 12, the subject matter of Examples 1-11 includes, wherein to transmit the plurality of parameters to the cloud service provider, the processor subsystem is to execute a script to transmit the plurality of parameters.

In Example 13, the subject matter of Examples 1-12 includes, wherein the processor subsystem is to audit the cloud project.

In Example 14, the subject matter of Examples 1-13 includes, wherein the processor subsystem is to: extract parameters of a deployed cloud configuration based on the cloud project; and compare the parameters of the deployed cloud configuration with the plurality of parameters in the proposed cloud configuration to determine whether an anomaly exists.

Example 15 is a method performed on an electronic online system, the method comprising: receiving, at the electronic online system, a proposed cloud configuration, the proposed cloud configuration including a plurality of parameters for use in instantiating and deploying a cloud project on a cloud service provider, wherein at least one of the plurality of parameters has corresponding metadata to describe an owner of the at least one of the plurality of parameters; saving the proposed cloud configuration in a pending approval queue; receiving an indication of approval of the at least one of the plurality of parameters by the owner indicated in the metadata of the at least one of the plurality of parameters; and after approval of all of the plurality of parameters in the proposed cloud configuration, transmitting the plurality of parameters to the cloud service provider to instantiate and deploy the cloud project.

In Example 16, the subject matter of Example 15 includes, wherein the plurality of parameters are used to configure a plurality of cloud resources.

In Example 17, the subject matter of Example 16 includes, wherein the plurality of cloud resources include compute resources or storage resources.

In Example 18, the subject matter of Examples 16-17 includes, wherein the proposed cloud configuration includes security requirements of at least one of the plurality of cloud resources.

In Example 19, the subject matter of Example 18 includes, wherein the security requirements include an indication of an encryption strength for use with the at least one of the plurality of cloud resources.

In Example 20, the subject matter of Examples 15-19 includes, wherein at least one of the plurality of parameters has corresponding metadata to describe a business value of the at least one of the plurality of parameters.

In Example 21, the subject matter of Examples 15-20 includes, wherein at least one of the plurality of parameters has corresponding metadata to describe a business cost of the at least one of the plurality of parameters.

In Example 22, the subject matter of Examples 15-21 includes, wherein at least one of the plurality of parameters has corresponding metadata to describe an approved range of operation of the at least one of the plurality of parameters.

In Example 23, the subject matter of Examples 15-22 includes, wherein at least one of the plurality of parameters has corresponding metadata to describe a security level of the at least one of the plurality of parameters.

In Example 24, the subject matter of Examples 15-23 includes, wherein transmitting the plurality of parameters to the cloud service provider includes using an application programming interface (API) to transmit the plurality of parameters.

In Example 25, the subject matter of Examples 15-24 includes, wherein transmitting the plurality of parameters to the cloud service provider includes using a command line interface (CLI) to transmit the plurality of parameters.

In Example 26, the subject matter of Examples 15-25 includes, wherein transmitting the plurality of parameters to the cloud service provider includes executing a script to transmit the plurality of parameters.

In Example 27, the subject matter of Examples 15-26 includes, auditing the cloud project.

In Example 28, the subject matter of Examples 15-27 includes, extracting parameters of a deployed cloud configuration based on the cloud project; and comparing the parameters of the deployed cloud configuration with the plurality of parameters in the proposed cloud configuration to determine whether an anomaly exists.

Example 29 is a non-transitory machine-readable medium comprising instructions, which when executed by a machine in an electronic online system, cause the machine to: receive, at the electronic online system, a proposed cloud configuration, the proposed cloud configuration including a plurality of parameters for use in instantiating and deploying a cloud project on a cloud service provider, wherein at least one of the plurality of parameters has corresponding metadata to describe an owner of the at least one of the plurality of parameters; save the proposed cloud configuration in a pending approval queue; receive an indication of approval of the at least one of the plurality of parameters by the owner indicated in the metadata of the at least one of the plurality of parameters; and after approval of all of the plurality of parameters in the proposed cloud configuration, transmit the plurality of parameters to the cloud service provider to instantiate and deploy the cloud project.

In Example 30, the subject matter of Example 29 includes, wherein the plurality of parameters are used to configure a plurality of cloud resources.

In Example 31, the subject matter of Example 30 includes, wherein the plurality of cloud resources include compute resources or storage resources.

In Example 32, the subject matter of Examples 30-31 includes, wherein the proposed cloud configuration includes security requirements of at least one of the plurality of cloud resources.

In Example 33, the subject matter of Example 32 includes, wherein the security requirements include an indication of an encryption strength for use with the at least one of the plurality of cloud resources.

In Example 34, the subject matter of Examples 29-33 includes, wherein at least one of the plurality of parameters has corresponding metadata to describe a business value of the at least one of the plurality of parameters.

In Example 35, the subject matter of Examples 29-34 includes, wherein at least one of the plurality of parameters has corresponding metadata to describe a business cost of the at least one of the plurality of parameters.

In Example 36, the subject matter of Examples 29-35 includes, wherein at least one of the plurality of parameters has corresponding metadata to describe an approved range of operation of the at least one of the plurality of parameters.

In Example 37, the subject matter of Examples 29-36 includes, wherein at least one of the plurality of parameters has corresponding metadata to describe a security level of the at least one of the plurality of parameters.

In Example 38, the subject matter of Examples 29-37 includes, wherein to transmit the plurality of parameters to the cloud service provider, the instructions cause the machine to use an application programming interface (API) to transmit the plurality of parameters.

In Example 39, the subject matter of Examples 29-38 includes, wherein to transmit the plurality of parameters to the cloud service provider, the instructions cause the machine to use a command line interface (CLI) to transmit the plurality of parameters.

In Example 40, the subject matter of Examples 29-39 includes, wherein to transmit the plurality of parameters to the cloud service provider, the instructions cause the machine to execute a script to transmit the plurality of parameters.

In Example 41, the subject matter of Examples 29-40 includes, wherein the instructions include instructions that cause the machine to audit the cloud project.

In Example 42, the subject matter of Examples 29-41 includes, wherein the instructions include instructions that cause the machine to: extract parameters of a deployed cloud configuration based on the cloud project; and compare the parameters of the deployed cloud configuration with the plurality of parameters in the proposed cloud configuration to determine whether an anomaly exists.

Example 43 is at least one machine-readable medium including instructions that, when executed by processing circuitry, cause the processing circuitry to perform operations to implement of any of Examples 1-42.

Example 44 is an apparatus comprising means to implement of any of Examples 1-42.

Example 45 is a system to implement of any of Examples 1-42.

Example 46 is a method to implement of any of Examples 1-42.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An electronic online system comprising:
a processor subsystem; and
a memory including instructions, which when executed by the processor subsystem, cause the processor subsystem to:
receive, from a submitter at the electronic online system, a proposed cloud configuration, the proposed cloud configuration including a plurality of parameters for use in instantiating and deploying a cloud project on a cloud service provider, wherein the plurality of parameters has corresponding metadata to describe a plurality of owners of the plurality of parameters, wherein each owner in the plurality of owners is assigned to approve a respective parameter in the plurality of parameters;
save the proposed cloud configuration in a pending approval queue;
receive an indication of approval of a first subset of the plurality of parameters by the plurality of owners indicated in the metadata;
receive a proposed revised cloud configuration, the propose revised cloud configuration including updates to a second subset of the plurality of parameters that were not approved;
notify the submitter of the proposed revised cloud configuration;
receive a second indication of approval from the submitter for the second subset of the plurality or parameters that were not approved; and
after approval of all of the plurality of parameters in the proposed cloud configuration by the plurality of owners, transmit the plurality of parameters to the cloud service provider to instantiate and deploy the cloud project.

2. The system of claim 1, wherein the plurality of parameters are used to configure a plurality of cloud resources.

3. The system of claim 2, wherein the plurality of cloud resources include compute resources or storage resources.

4. The system of claim 2, wherein the proposed cloud configuration includes security requirements of at least one of the plurality of cloud resources.

5. The system of claim 4, wherein the security requirements include an indication of an encryption strength for use with the at least one of the plurality of cloud resources.

6. The system of claim 1, wherein at least one of the plurality of parameters has corresponding metadata to describe a business value of the at least one of the plurality of parameters.

7. The system of claim 1, wherein at least one of the plurality of parameters has corresponding metadata to describe a business cost of the at least one of the plurality of parameters.

8. The system of claim 1, wherein at least one of the plurality of parameters has corresponding metadata to describe an approved range of operation of the at least one of the plurality of parameters.

9. The system of claim 1, wherein at least one of the plurality of parameters has corresponding metadata to describe a security level of the at least one of the plurality of parameters.

10. The system of claim 1, wherein to transmit the plurality of parameters to the cloud service provider, the processor subsystem is to use an application programming interface (API) to transmit the plurality of parameters.

11. The system of claim 1, wherein to transmit the plurality of parameters to the cloud service provider, the processor subsystem is to use a command line interface (CLI) to transmit the plurality of parameters.

12. The system of claim 1, wherein to transmit the plurality of parameters to the cloud service provider, the processor subsystem is to execute a script to transmit the plurality of parameters.

13. The system of claim 1, wherein the processor subsystem is to audit the cloud project.

14. The system of claim 1, wherein the processor subsystem is to:
extract parameters of a deployed cloud configuration based on the cloud project; and
compare the parameters of the deployed cloud configuration with the plurality of parameters in the proposed cloud configuration to determine whether an anomaly exists.

15. A method performed on an electronic online system, the method comprising:
receiving, from a submitter at the electronic online system, a proposed cloud configuration, the proposed cloud configuration including a plurality of parameters for use in instantiating and deploying a cloud project on a cloud service provider, wherein the plurality of parameters has corresponding metadata to describe a plurality of owners of the plurality of parameters, wherein each owner in the plurality of owners is assigned to approve a respective parameter in the plurality of parameters;
saving the proposed cloud configuration in a pending approval queue;
receiving an indication of approval of a first subset of the plurality of parameters by the plurality of owners indicated in the metadata;
receiving a proposed revised cloud configuration, the propose revised cloud configuration including updates to a second subset of the plurality of parameters that were not approved;
notifying the submitter of the proposed revised cloud configuration;
receiving a second indication of approval from the submitter for the second subset of the plurality or parameters that were not approved; and
after approval of all of the plurality of parameters in the proposed cloud configuration by the plurality of owners, transmitting the plurality of parameters to the cloud service provider to instantiate and deploy the cloud project.

16. The method of claim 15, further comprising auditing the cloud project.

17. The method of claim 15, further comprising:
extracting parameters of a deployed cloud configuration based on the cloud project; and
comparing the parameters of the deployed cloud configuration with the plurality of parameters in the proposed cloud configuration to determine whether an anomaly exists.

18. A non-transitory machine-readable medium comprising instructions, which when executed by a machine in an electronic online system, cause the machine to:
receive, from a submitter at the electronic online system, a proposed cloud configuration, the proposed cloud configuration including a plurality of parameters for use in instantiating and deploying a cloud project on a cloud service provider, wherein the plurality of parameters has corresponding metadata to describe a plurality of owners of the plurality of parameters, wherein each owner in the plurality of owners is assigned to approve a respective parameter in the plurality of parameters;
save the proposed cloud configuration in a pending approval queue;
receive an indication of approval of a first subset of the plurality of parameters by the plurality of owners indicated in the metadata;
receive a proposed revised cloud configuration, the propose revised cloud configuration including updates to a second subset of the plurality of parameters that were not approved;
notify the submitter of the proposed revised cloud configuration;
receive a second indication of approval from the submitter for the second subset of the plurality or parameters that were not approved; and
after approval of all of the plurality of parameters in the proposed cloud configuration by the plurality of owners, transmit the plurality of parameters to the cloud service provider to instantiate and deploy the cloud project.

19. The machine-readable medium of claim 18, wherein the instructions include instructions that cause the machine to audit the cloud project.

20. The machine-readable medium of claim 18, wherein the instructions include instructions that cause the machine to:
extract parameters of a deployed cloud configuration based on the cloud project; and
compare the parameters of the deployed cloud configuration with the plurality of parameters in the proposed cloud configuration to determine whether an anomaly exists.
